(19) United States
(12) Patent Application Publication
(10) Pub. No.: US 2008/0316333 A1
(43) Pub. Date: Dec. 25, 2008

(54) IMAGING APPARATUS, IMAGING METHOD, PROGRAM, AND INTEGRATED CIRCUIT

(76) Inventors: Hideyuki FURUYA, Osaka (JP); Tadami Mine, Osaka (JP); Norikatsu Yoshida, Hyogo (JP)

Correspondence Address: WENDEROTH, LIND & PONACK L.L.P., 2033 K. STREET, NW, SUITE 800, WASHINGTON, DC, 20006, US

(21) Appl. No.: 12/141,540

(22) Filed: Jun. 18, 2008

(30) Foreign Application Priority Data
Jun. 19, 2007 (JP) 2007-161148

(51) Int. Cl. H04N 5/235

(52) U.S. Cl. 348/229.1; 348/E05.034

(57) ABSTRACT

An imaging apparatus enables flicker correction with small errors even when illumination changes in the image capturing environment or when the imaging apparatus is moved. In an imaging apparatus 100, an imaging unit 1 obtains an image-A signal including no flicker element and an image-B signal including a flicker element for each frame, an image-B gain calculation unit 3 calculates a correction coefficient for eliminating the flicker element included in the image-B signal based on the image-A signal and the image-B signal, an image-B gain correction unit 5 eliminates the flicker element from the image-B signal based on the correction coefficient, and an image A/B combining unit 6 combines the image-A signal and the image-B signal. In this manner, the imaging apparatus 100 generates an image signal from which the flicker element has been eliminated.

### BACKGROUND OF THE INVENTION

1. Field of the Invention

The present invention relates to a technique for correcting a flicker phenomenon that occurs when an image is captured using an imaging apparatus including an XY-driving image sensor, such as a metal oxide semiconductor (MOS) image sensor, under illumination whose luminance varies depending on power supply frequencies.

2. Description of the Related Art

When an image is captured under illumination whose luminance varies depending on power supply frequencies, the captured image may have flicker, which needs to be detected and corrected. An imaging apparatus including an XY-driving image sensor with a frame rate of 60 fps, such as a MOS image sensor, may have flicker under illumination of a power supply with a power supply frequency of 50 Hz. Flicker of such an imaging apparatus will now be described in detail with reference to FIG. 5. As shown in FIG. 5, the image sensor of the imaging apparatus exposes different lines at different exposure timings. When the image sensor is driven with a certain exposure time, the lines of the image sensor accumulate different amounts of light. That causes horizontal lines of flicker, which are repeated every three frames, to occur on a captured image (video).

When the image sensor is driven with an exposure time of 1/100 second, that is, when the image sensor is driven to expose for the time corresponding to half the cycle of the power supply frequency of the illumination, the lines of the image sensor all accumulate the same amount of light. In this case, the imaging apparatus captures an image (video) without horizontal lines of flicker. Based on this widely known fact, the image sensor is usually driven with the exposure time of 1/100 second to eliminate flicker in a simple manner when flicker is detected under the illumination with the power supply frequency of 50 Hz.

In this case, however, the exposure time of the imaging device is fixed short. The image sensor obtains a video signal with a lower output level when the exposure time is short, as compared with when the exposure time of the image sensor is long. To increase the output level of a video signal obtained by the image sensor, the gain of the amplifier needs to be set large. However, increasing the gain of the amplifier would degrade the signal-to-noise (S/N) ratio of the video signal.

To detect flicker in a conventional imaging apparatus, an imaging unit may be driven with two different exposure times for the first frame. The imaging unit may then be driven in a normal manner with one exposure time for the second and subsequent frames. To correct flicker, the gain of an amplifier subsequent to the imaging unit is adjusted. For ease of explanation, the power supply frequency of the illumination used for the conventional imaging apparatus is assumed to be 50 Hz.

FIG. 6 is a diagram describing gain adjustment between an image of the first frame that is formed by the imaging unit driven with two different exposure times and an image of the second or subsequent frame that is formed by the imaging unit driven in a normally manner.

Flicker correction performed by the conventional imaging apparatus will have large errors if pixels (pixels of the image sensor) of images that are formed with the two different exposure times are not adjacent to each other. The image sensor is assumed to be driven with the two different exposure times ( 1/100 second and 1/60 second) to expose lines of pixels included in the image sensor for the first frame (for example, pixels in odd lines are exposed with the exposure time of 1/100 second, whereas pixels in even lines are exposed with the exposure time of 1/60 second). In this case, an image formed with the exposure time of 1/100 second (image A) will have no flicker, whereas an image formed with the exposure time of 1/60 second (image B) will have flicker. The imaging apparatus then divides the image B by the image A. As a result, the subject images of the images A and B cancel out to generate an image C (C=B/A), which has a luminance pattern corresponding only to the flicker element. The imaging apparatus also calculates an output waveform V of an image that is obtained by vertically projecting the image C. The imaging apparatus also obtains a gain correction coefficient that is proportional to the phase opposite to the phase of the output waveform V.

The conventional imaging apparatus drives the imaging unit in a normal manner for the second or subsequent frame. The amplifier subsequent to the imaging unit then multiplies the resulting image signal by the gain correction coefficient obtained for the first frame whose vertical phase has been shifted. In this manner, the conventional imaging apparatus obtains the corrected image signal, from which the flicker element has been eliminated.

FIG. 4 shows the overall structure of a conventional imaging apparatus 400.

The imaging apparatus 400 includes an imaging unit 401, an exposure time control circuit 402, a flicker detection circuit 403, a gain control circuit 404, and a gain variable amplifier 405. The imaging unit 401 converts light from a subject by photoelectric conversion to generate a video signal (image signal). The exposure time control circuit 402 outputs an exposure time control signal, which is used to control the exposure time of the image sensor, to the imaging unit 401. The flicker detection circuit 403 detects flicker based on an image signal output from the imaging unit 401. The gain control circuit 404 determines a gain correction coefficient based on an output of the flicker detection circuit 403. Based on the gain correction coefficient, the gain variable amplifier 405 changes the gain to be multiplied by an image signal corresponding to the second or subsequent frame, which is output from the imaging unit 401. Although not shown, the imaging apparatus 400 further includes a central control unit that controls the operation of each unit, such as the operation timing of each unit.

The imaging unit 401 includes a pixel unit (image sensor), a vertical shift register, a first horizontal shift register and a first line memory, and a second horizontal shift register and a second line memory. The vertical shift register is assigned to all lines of the pixel unit. The first horizontal shift register and the first line memory are assigned to odd lines of the pixel unit. The second horizontal shift register and the second line memory are assigned to even lines of the pixel unit. The pixels in the odd lines of the pixel unit are driven with the exposure time of 1/100 second, with which no flicker is generated under a power supply illumination with a power supply frequency of 50 Hz. The pixels in the even lines of the pixel unit are driven with the exposure time of 1/60 second, with which no flicker is generated under a power supply illumination with a power supply frequency of 60 Hz.

The exposure time control circuit 402 outputs an exposure time control signal to the imaging unit 401. The exposure time control signal causes the pixels in the odd lines of the pixel unit (image sensor) of the imaging unit 401 and the pixels in the even lines of the pixel unit to be driven with two different exposure times.

The flicker detection circuit 403 detects a flicker element based on an image signal corresponding to the first frame, which is output from the imaging unit 401, and provides (outputs) the detection signal to the gain control circuit 404.

The gain control circuit 404 calculates a gain correction coefficient corresponding to the correction gain that is proportional to the phase opposite to the phase of the flicker element detected by the flicker detection circuit 403. The gain control circuit 404 then outputs the gain correction coefficient to the gain variable amplifier 405.

When the flicker detection circuit 403 detects flicker in the image signal corresponding to the first frame, the gain variable amplifier 405 multiplies an image signal corresponding to the second or subsequent frame, which is output from the imaging unit 401, by the gain correction coefficient, which is output from the gain control circuit 404. Through this process, the gain variable amplifier 405 eliminates the flicker element from the image signal. The gain variable amplifier 405 then outputs the corrected image signal, from which the flicker element has been cancelled out (eliminated). When the flicker detection circuit 403 detects no flicker in the image signal corresponding to the first frame, the gain variable amplifier 405 outputs the image signal without flicker, which is output from the imaging unit 401, without processing the image signal.

FIG. 7 is a flowchart schematically showing the overall operation of the conventional imaging apparatus 400.

As described above, the imaging apparatus 400 obtains the image A and the image B corresponding to the first frame (steps 702 and 703), and divides the image B (image signal for the image B) by the image A (image signal for the image A) to generate the image C (step 704). The imaging apparatus 400 detects flicker based on the image C (step 705). When detecting no flicker, the imaging apparatus 400 performs a normal operation for the second and subsequent frames (step 707). When detecting flicker, the imaging apparatus 400 performs a flicker correction operation for images corresponding to the second and subsequent frames (step 708). The apparatus conditions associated with flicker may change during the image capturing operation of the imaging apparatus 400. Considering this, the imaging apparatus 400 determines whether the imaging apparatus 400 has received an instruction to end the image capturing operation (step 708). When receiving no such instruction, the imaging apparatus 400 again detects flicker every after a predetermined period elapses, or every after the imaging apparatus 400 processes X frames (where X is a natural number) (steps 710 and 711).

Patent Citation 1: Japanese Unexamined Patent Publication No. 2006-245784 ([0030] to [0054])

### SUMMARY OF THE INVENTION

### Technical Problem

However, the above conventional imaging apparatus detects a flicker element of an image corresponding to only a single frame out of a plurality of frames, and calculates a gain correction value based on phase information of the detected flicker element. More specifically, the imaging apparatus detects a flicker element using one frame and corrects a flicker element of another frame. When, for example, the illumination changes with time in the image capturing environment or when the imaging apparatus is moved to alternately capture an image of an indoor scene and an image of an outdoor scene, the flicker correction performed by the conventional imaging apparatus would have errors.

To solve the above problem, it is an object of the present invention to provide an imaging apparatus, an imaging method, a program, and an integrated circuit that enable flicker correction with small errors even when the illumination changes in the image capturing environment or when the imaging apparatus is moved.

### Technical Solution

A first aspect of the present invention provides an imaging apparatus including an imaging unit, an exposure time control unit, an image-B gain calculation unit, an image-B gain correction unit, and an image-A/B combining unit. The imaging unit includes an image sensor having a first group of pixels and a second group of pixels that are driven independently of each other. The exposure time control unit sets an exposure time for the pixels included in the first group as a first exposure time with which no flicker element is generated and an exposure time for the pixels included in the second group as a second exposure time, and controls an exposure time for the first group to be the first exposure time and an exposure time for the second group to be the second exposure time. The image-B gain calculation unit calculates a gain correction coefficient for correcting a flicker element of an image-B signal based on an image-A signal including no flicker element obtained using the first group and the image-B signal obtained using the second group. The image-B gain correction unit corrects the flicker element of the image-B signal based on the gain correction coefficient. The image-A/B combining unit combines the image-B signal whose flicker element has been corrected by the image-B gain correction unit and the image-A signal in accordance with an arrangement of the first group and the second group that are arranged on the image sensor.

This imaging apparatus obtains an image-A signal including no flicker element and an image-B signal including a flicker element for each frame, and calculates a gain correction coefficient for eliminating the flicker element included in the image-B signal based on the image-A signal and the image-B signal. The imaging apparatus combines the image-A signal and the image-B signal after eliminating the flicker element from the image-B signal based on the correction coefficient. As a result, the imaging apparatus generates an image signal from which the flicker element has been eliminated.

As a result, even when the illumination changes in the image capturing environment or when the imaging apparatus is moved, the imaging apparatus enables flicker correction with small errors.

The “flicker element” herein refers to a flicker element of a captured image that can occur due to the power supply frequency of the illumination arranged in the surrounding environment of the imaging apparatus.

A second aspect of the present invention provides the imaging apparatus of the first aspect of the present invention in which the imaging unit includes the image sensor in which the pixels included in the first group and the pixels included in the second group are arranged adjacent to each other in a vertical direction and a horizontal direction of an imaging surface of the image sensor.

In this imaging apparatus, the pixels included in the first group are not adjacent to one another in the vertical and horizontal directions on the imaging surface of the image sensor, and the pixels included in the second group are not adjacent to one another in the vertical and horizontal directions on the imaging surface of the image sensor. In other words, the pixels arranged on the imaging surface of the image sensor are driven with the two different exposure times in a manner that alternate pixels arranged in the vertical and horizontal directions are driven with one exposure time and the remaining alternate pixels are driven with the other exposure time. This reduces visibility of vertical lines of noise, which can occur on the processed image due the different exposure times.

A third aspect of the present invention provides the imaging apparatus of the first or second aspect of the present invention in which the exposure time control unit sets the first exposure time at n/100 second (n is a natural number) when a power supply frequency of illumination is 50 Hz, and sets the first exposure time at n/120 second (n is a natural number) when the power supply frequency of the illumination is 60 Hz.

This imaging apparatus easily generates the image-A signal including no flicker element.

It is preferable that n is an integer that sets the first exposure time at a maximum value that is not greater than the time corresponding to one frame.

A fourth aspect of the present invention provides an imaging method that is used in the imaging apparatus including an imaging unit whose image sensor has a first group of pixels and a second group of pixels that are driven independently of each other. The method includes an exposure time control process, an image-B gain calculation process, an image-B gain correction process, and an image-A/B combining process. In the exposure time control process, an exposure time for the pixels included in the first group is set as a first exposure time with which no flicker element is generated and an exposure time for the pixels included in the second group is set as a second exposure time, and an exposure time for the first group is controlled to be the first exposure time and an exposure time for the second group is controlled to be the second exposure time. In the image-B gain calculation process, a gain correction coefficient for correcting a flicker element of an image-B signal is calculated based on an image-A signal including no flicker element obtained using the first group and the image-B signal obtained using the second group. In the image-B gain correction process, the flicker element of the image-B signal is corrected based on the gain correction coefficient. In the image-A/B combining process, the image-B signal whose flicker element has been corrected in the image-B gain correction process and the image-A signal are combined in accordance with an arrangement of the first group and the second group that are arranged on the image sensor.

When this method is used in the imaging apparatus that includes the imaging unit whose image sensor includes the first group of pixels and the second group of pixels that are driven independently of each other, the imaging method has the same advantageous effects as the imaging apparatus of the first aspect of the present invention.

A fifth aspect of the present invention provides a storage medium storing a computer-readable program that is used in an imaging apparatus including an imaging unit whose image sensor has a first group of pixels and a second group of pixels that are driven independently of each other. The program enables a computer to function as an exposure time control unit, an image-B gain calculation unit, an image-B gain correction unit, and an image-A/B combining unit. The exposure time control unit sets an exposure time for the pixels included in the first group as a first exposure time with which no flicker element is generated and an exposure time for the pixels included in the second group as a second exposure time, and controls an exposure time for the first group to be the first exposure time and an exposure time for the second group to be the second exposure time. The image-B gain calculation unit calculates a gain correction coefficient for correcting a flicker element of an image-B signal based on an image-A signal including no flicker element obtained using the first group and the image-B signal obtained using the second group. The image-B gain correction unit corrects the flicker element of the image-B signal based on the gain correction coefficient. The image-A/B combining unit combines the image-B signal whose flicker element has been corrected by the image-B gain correction unit and the image-A signal in accordance with an arrangement of the first group and the second group that are arranged on the image sensor.

When this program is used in the imaging apparatus that includes the imaging unit whose image sensor includes the first group of pixels and the second group of pixels that are driven independently of each other, the program has the same advantageous effects as the imaging apparatus of the first aspect of the present invention.

A sixth aspect of the present invention provides an integrated circuit including an imaging unit, an exposure time control unit, an image-B gain calculation unit, an image-B gain correction unit, and an image-A/B combining unit. The imaging unit includes an image sensor having a first group of pixels and a second group of pixels that are driven independently of each other. The exposure time control unit sets an exposure time for the pixels included in the first group as a first exposure time with which no flicker element is generated and an exposure time for the pixels included in the second group as a second exposure time, and controls an exposure time for the first group to be the first exposure time and an exposure time for the second group to be the second exposure time. The image-B gain calculation unit calculates a gain correction coefficient for correcting a flicker element of an image-B signal based on an image-A signal including no flicker element obtained using the first group and the image-B signal obtained using the second group. The image-B gain correction unit corrects the flicker element of the image-B signal based on the gain correction coefficient. The image-A/B combining unit combines the image-B signal whose flicker element has been corrected by the image-B gain correction unit and the image-A signal in accordance with an arrangement of the first group and the second group that are arranged on the image sensor.

The integrated circuit has the same advantageous effects as the imaging apparatus of the first aspect of the present invention.

A seventh aspect of the present invention provides an integrated circuit that is used in an imaging apparatus including an imaging unit whose image sensor has a first group of pixels and a second group of pixels that are driven independently of each other. The integrated circuit includes an exposure time control unit, an image-B gain calculation unit, an image-B gain correction unit, and an image-A/B combining unit. The exposure time control unit sets an exposure time for the pixels included in the first group as a first exposure time with which no flicker element is generated and an exposure time for the pixels included in the second group as a second exposure time, and controls an exposure time for the first group to be the first exposure time and an exposure time for the second group to be the second exposure time. The image-B gain calculation unit calculates a gain correction coefficient for correcting a flicker element of an image-B signal based on an image-A signal including no flicker element obtained using the first group and the image-B signal obtained using the second group. The image-B gain correction unit corrects the flicker element of the image-B signal based on the gain correction coefficient. The image-A/B combining unit combines the image-B signal whose flicker element has been corrected by the image-B gain correction unit and the image-A signal in accordance with an arrangement of the first group and the second group that are arranged on the image sensor.

When this integrated circuit is used in the imaging apparatus that includes the imaging unit whose image sensor includes the first group of pixels and the second group of pixels that are driven independently of each other, the integrated circuit has the same advantageous effects as the imaging apparatus of the first aspect of the present invention.

### ADVANTAGEOUS EFFECTS

The present invention provides an imaging apparatus, an imaging method, a program, and an integrated circuit that enable flicker correction with small errors even when the illumination changes in the image capturing environment or when the imaging apparatus is moved.

### BRIEF DESCRIPTION OF THE DRAWINGS

FIG. 1 shows the structure of an imaging apparatus 100 according to a first embodiment of the present invention.

FIG. 2 schematically shows the structure of an imaging unit 1 included in the imaging apparatus 100 according to the first embodiment of the present invention.

FIG. 3 is a flowchart showing the operation of the imaging apparatus 100 according to the first embodiment of the present invention.

FIG. 4 shows the structure of a conventional imaging apparatus 400.

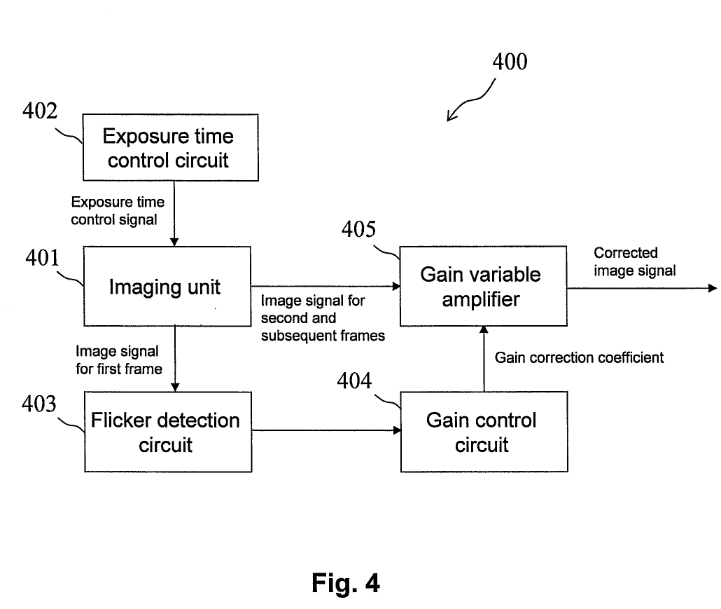

FIG. 5 is a diagram describing flicker generated in a typical imaging apparatus with a frame rate of 60 fps under illumination with a power supply frequency of 50 Hz.

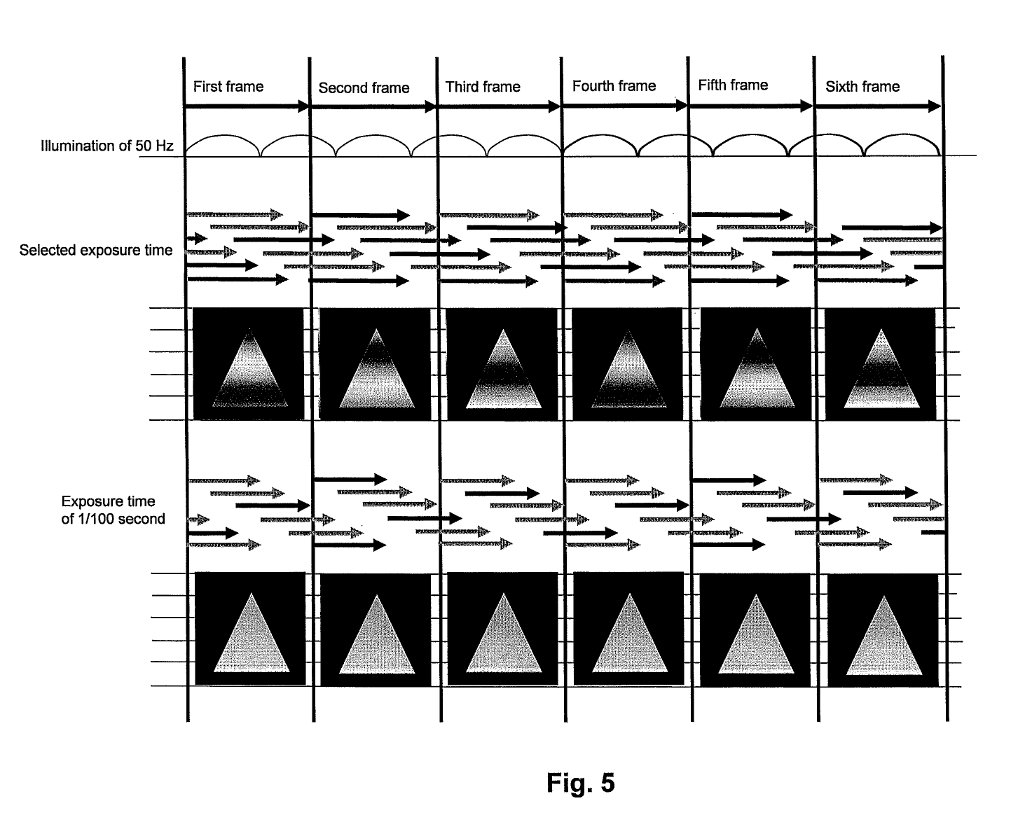

FIG. 6 is a diagram describing the operation of the conventional imaging apparatus 400.

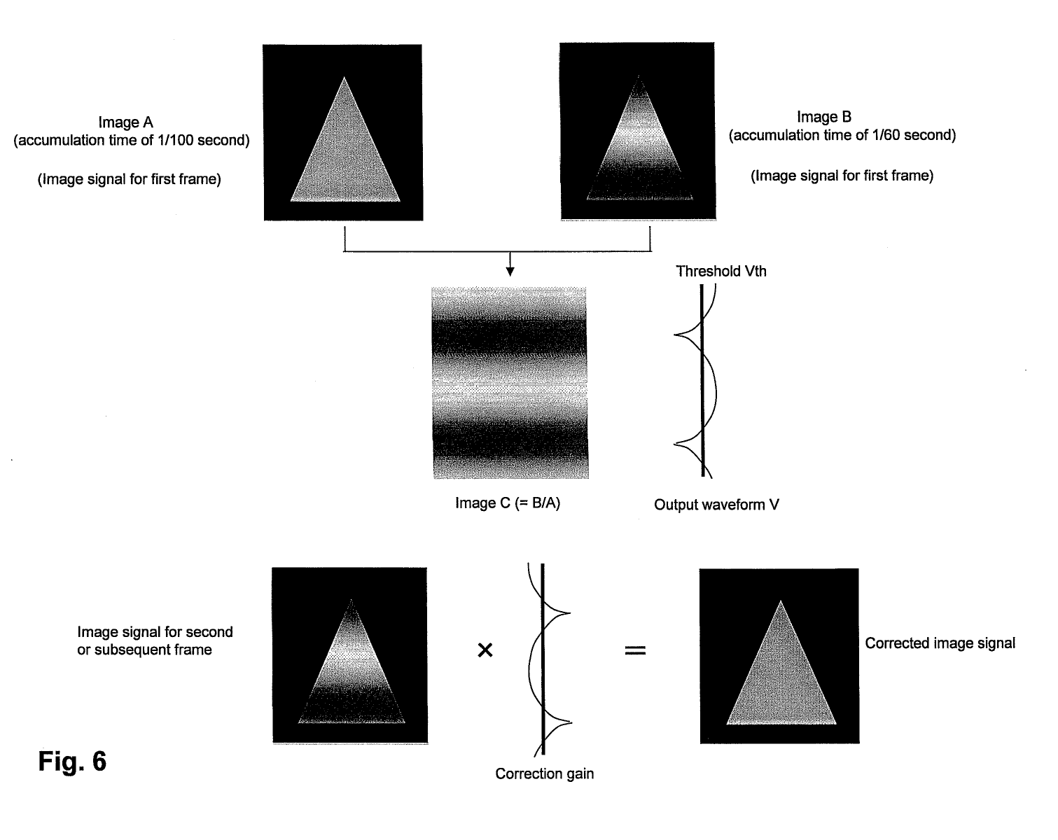

FIG. 7 is a flowchart showing the operation of the conventional imaging apparatus.

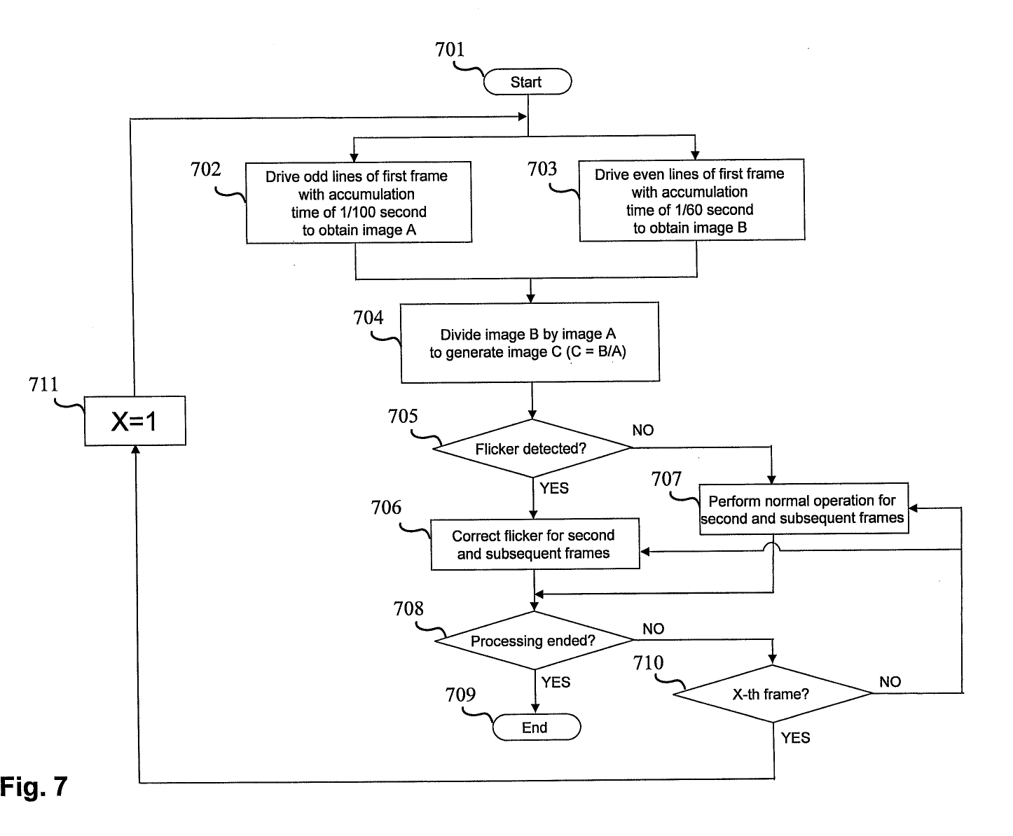

### EXPLANATION OF REFERENCE

100 imaging apparatus
1 imaging unit
2 exposure time control unit
3 image-B gain calculation unit
4 delay unit
5 image-B gain correction unit
6 image-A/B combining unit
11 pixel unit (image sensor)

### BEST MODE FOR CARRYING OUT THE INVENTION

An embodiment of the present invention will now be described with reference to the drawings.

### First Embodiment

### 1. Structure of the Imaging Apparatus

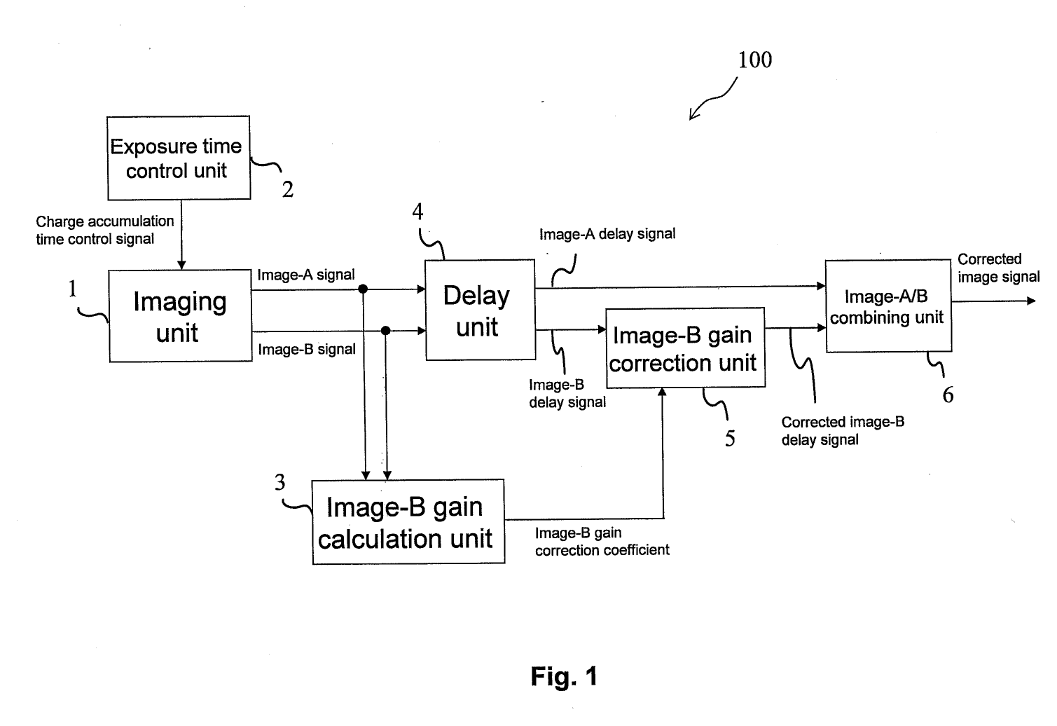

FIG. 1 shows the structure of an imaging apparatus 100 according to a first embodiment of the present invention.

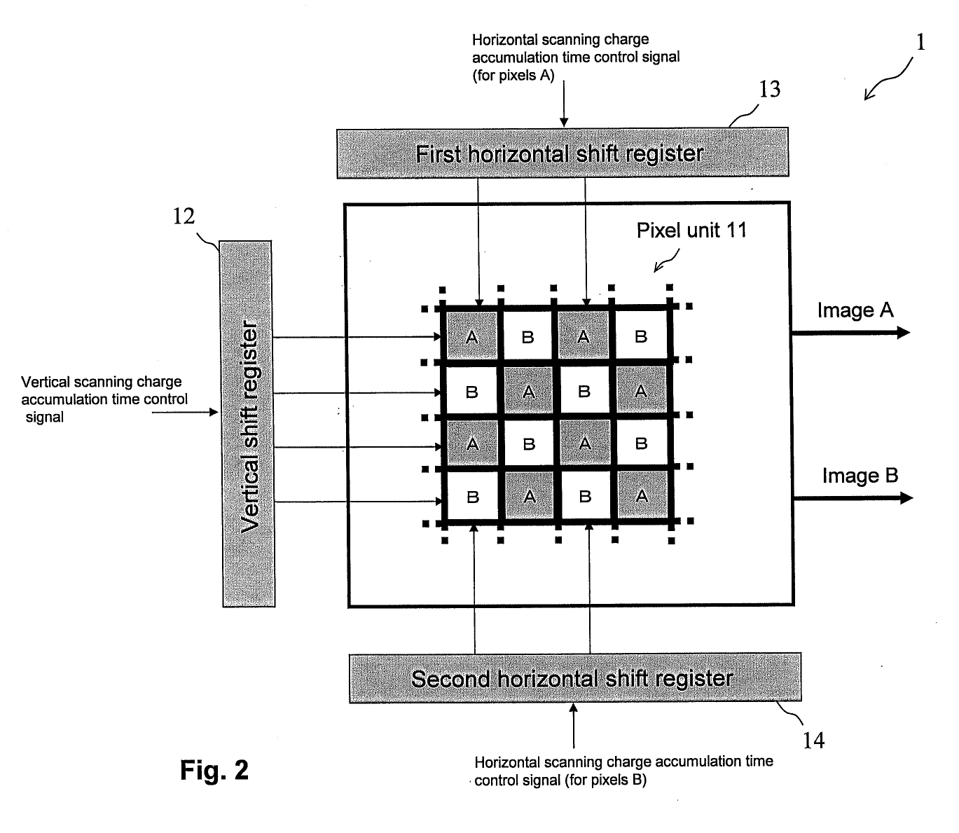

FIG. 2 is a conceptual diagram of an image sensor including pixels that are driven with two different exposure times in a manner that alternate pixels in vertical and horizontal directions on an imaging surface of an imaging unit 1 are driven with one exposure time and the remaining alternate pixels are driven with the other exposure time.

The imaging apparatus 100 includes an imaging unit 1, an exposure time control unit 2, and an image-B gain calculation unit 3. The imaging unit 1 converts light from a subject by photoelectric conversion to generate an image-A signal and an image-B signal. The exposure time control unit 2 outputs a charge accumulation time control signal to the imaging unit 1. The charge accumulation time control signal is used to control the charge accumulation time of each pixel of the image sensor of the imaging unit 1. The image-B gain calculation unit 3 calculates an image-B gain correction coefficient based on the image-A signal and the image-B signal, which are output from the imaging unit. The imaging apparatus 100 further includes a delay unit 4, an image-B gain correction unit 5, and an image-A/B combining unit 6. The delay unit 4 delays the image-A signal and the image-B signal, which are output from the imaging unit 1, each by a predetermined time, and outputs the delayed signals as an image-A delay signal and an image-B delay signal. The image-B gain correction unit 5 subjects the image-B delay signal to gain correction based on the image-B gain correction coefficient. The image A/B combining unit 6 combines the image-A delay signal and the image-B delay signal, which is corrected by the image-B gain correction unit 5, and outputs the resulting signal as a corrected image signal.

The imaging unit 1 includes a pixel unit 11 (image sensor), a vertical shift register 12, a first horizontal shift register 13, and a second horizontal shift register 14. The pixel unit 11 includes a plurality of pixels. The vertical shift register 12 outputs a drive signal for driving pixels in all lines of the pixel unit 11 to the pixel unit 11 based on a charge accumulation time control signal, which is provided from the exposure time control unit 2. The first horizontal shift register 13 outputs a drive signal for driving pixels with letter A in FIG. 2 (these pixels are referred to as “pixels A”, which form an “image A”) to the pixel unit 11. The second horizontal shift register 14 outputs a drive signal for driving pixels with letter B in FIG. 2 (these pixels are referred to as “pixels B”, which form an “image B”) to the pixel unit 11. The imaging unit 1 has an output channel for the image A and an output channel for the image B.

The imaging unit 1 converts light from a subject by photoelectric conversion to generate an image signal. The imaging unit 1 obtains an image signal using the pixels A and outputs the resulting signal as an image-A signal to the delay unit 4. The imaging unit 1 obtains an image signal using the pixels B and outputs the resulting signal as an image-B signal to the image-B gain calculation unit 3.

As shown in FIG. 2, the imaging unit 1 drives the pixels on the same imaging surface (imaging surface of the pixel unit 11 (image sensor) consisting of a plurality of pixels) with two different exposure times in a manner that alternate pixels in the horizontal and vertical directions are driven with one exposure time and the remaining alternate pixels are driven with the other exposure time. The imaging unit 1 then separately outputs an image (image A) signal obtained using the pixels driven with the first exposure time, with which no flicker is generated, and an image (image B) signal obtained using the pixels driven with the second exposure time, with which flicker is generated.

The arrangement of the pixels A and the pixels B in the pixel unit 11 should not be limited to the arrangement shown in FIG. 2. The charge accumulation time control signal from the exposure time control unit 2 is input into the vertical shift register 12, the first horizontal shift register 13, and the second horizontal shift register 14. Based on the charge accumulation time control signal, the vertical shift register 12, the first horizontal shift register 13, and the second horizontal shift register 14 generate a drive signal for driving the pixels of the pixel unit 11 in a manner that pixels are driven with their predetermined exposure times (charge accumulation times). FIG. 2 shows the case in which the charge accumulation time control signal includes a vertical scanning charge accumulation time control signal, a horizontal scanning charge accumulation time control signal (for pixels A), and a horizontal scanning charge accumulation time control signal (for pixels B). As shown in FIG. 2, the vertical scanning charge accumulation time control signal is input into the vertical shift register 12, the horizontal scanning charge accumulation time control signal (for pixels A) is input into the first horizontal shift register, and the horizontal scanning charge accumulation time control signal (for pixels B) is input into the second horizontal shift register. The vertical shift register 12 generates a drive signal for driving the pixels of the pixel unit 11 based on the vertical scanning charge accumulation time control signal. The first horizontal shift register generates a drive signal for driving the pixels A of the pixel unit 11 based on the horizontal scanning charge accumulation time control signal (for pixels A). The second horizontal shift register generates a drive signal for driving the pixels B of the pixel unit 11 based on the horizontal scanning charge accumulation time control signal (for pixels B). The pixels A of the pixel unit 11 are driven based on a drive signal generated by the vertical shift register 12 and a drive signal generated by the first horizontal shift register 13. The pixels B of the pixel unit 11 are driven based on a drive signal generated by the vertical shift register 12 and a drive signal generated by the second horizontal shift register 14. The exposure time for the pixels A and the exposure time for the pixels B are controlled using the vertical scanning charge accumulation time control signal, the horizontal scanning charge accumulation time control signal (for pixels A), and the horizontal scanning charge accumulation time control signal (for pixels B).

It is preferable to use a complementary metal oxide semiconductor (CMOS) image sensor as the imaging unit 1.

The exposure time control unit 2 outputs a charge accumulation time control signal to the imaging unit 1. The charge accumulation time control signal is used to set the exposure time of each pixel of the pixel unit 11 of the imaging unit 1 to a predetermined time. As shown in FIG. 2, the charge accumulation time control signal may include the vertical scanning charge accumulation time control signal, the horizontal scanning charge accumulation time control signal (for pixels A), and the horizontal scanning charge accumulation time control signal (for pixels B).

The exposure time control unit 2 sets the charge accumulation time control signal to set the exposure time of the pixels of the pixel unit 11 of the imaging unit 1 to their predetermined times.

The exposure time control unit 2 sets the charge accumulation time control signal in a manner that the first exposure time (exposure time for pixels A) is set at n/100 second (where n is an integer that sets the exposure time at a maximum value not greater than the time corresponding to one frame), and sets the charge accumulation time control signal in a manner that the second exposure time (exposure time for pixels B) is set at any selected time. The exposure time control unit 2 sets the charge accumulation time control signal in a manner that the first exposure time (exposure time for pixels A) is set at n/120 second (where n is an integer that sets the exposure time at a maximum value not greater than a one-frame time) when the illumination power supply frequency is 60 Hz, and sets the charge accumulation time control signal in a manner that the second exposure time (exposure time for pixels B) is set at any selected time. For ease of explanation, the power supply frequency of the illumination is assumed to be 50 Hz.

The image-B gain calculation unit 3 receives the image-A signal and the image-B signal output from the imaging unit 1, and calculates the image-B gain correction coefficient for each line based on the image-A signal and the image-B signal (the calculation method will be described in detail later), and outputs the calculated image-B gain correction coefficient to the image-B gain correction unit 5. The image-A signal herein includes no flicker element, whereas the image-B signal herein includes a flicker element.

The delay unit 4 delays the image-A signal, which is output from the imaging unit 1, by a predetermined time, and outputs the delayed signal as an image-A delay signal to the image A/B combining unit. The delay unit 4 also delays the image-B signal, which is output from the imaging unit 1, by a predetermined time, and outputs the delayed signal as an image-B delay signal to the image-B gain correction unit 5. More specifically, the delay unit 4 delays the image-B signal by the time required by processing performed in the image-B gain calculation unit in a manner that the image-B signal will be processed at a right timing in the image-B gain correction unit 5. The delay unit 4 delays the image-A signal by the time required by processing performed in the image-B gain calculation unit 3 and the image-B gain correction unit 5 in a manner that the image-A signal will be processed at a right timing in the image-A/B combining unit 6.

A frame memory may be used as the delay unit 4. A delay unit for the image-A signal and a delay unit for the image-B signal may be arranged separately.

The image-B gain correction unit 5 receives the image-B gain correction coefficient, which is output from the image-B gain calculation unit 3, and the image-B delay signal, which is output from the delay unit 4. For each line, the image-B gain correction unit 5 multiplies the image-B delay signal by the image-B gain correction coefficient to eliminate (cancel) a flicker element included in the image-B delay signal. The image-B gain correction unit 5 then outputs the image-B delay signal from which the flicker element has been removed (canceled out) (the corrected image-B delay signal) to the image-A/B combining unit 6.

The image-A/B combining unit 6 receives the image-A delay signal, which is output from the delay unit 4, and the corrected image-B delay signal, which is output from the image-B gain correction unit 5, and combines the image-A delay signal and the corrected image-B delay signal to generate a corrected image signal. The image-A/B combining unit 6 then outputs the corrected image signal.

More specifically, the image-A/B combining unit 6 combines the image-A delay signal and the corrected image-B delay signal in the same arrangement as the arrangement of the imaging surface of the imaging unit 1 (in the same arrangement as the arrangement of the pixels of the pixel unit 11) to generate a corrected image signal. The image-A/B combining unit 6 then outputs the corrected image signal.

Although not shown, the imaging apparatus 100 further includes an overall control unit that controls each unit of the imaging apparatus 100 (including the operation timing of each unit).

When the odd lines of the pixel unit 11 are driven with the first exposure time and the even lines of the pixel unit 11 are driven with the second exposure time, the imaging apparatus 100 would have vertical lines of noise that occur due to different correction gains of different lines. To reduce visibility of such noise, the imaging apparatus 100 drives the pixels with two different exposure times in a manner that alternate pixels arranged in the vertical and horizontal directions are driven with one exposure time and the remaining alternate pixels are driven with the other exposure time as shown in FIG. 2 (meaning that each pixel of the pixel unit 11 is driven with the exposure time different from the exposure time of pixels adjacent to the pixel in the vertical and horizontal directions).

### 2. Operation of the Imaging Apparatus

The operation of the imaging apparatus 100 with the above-described structure will now be described.

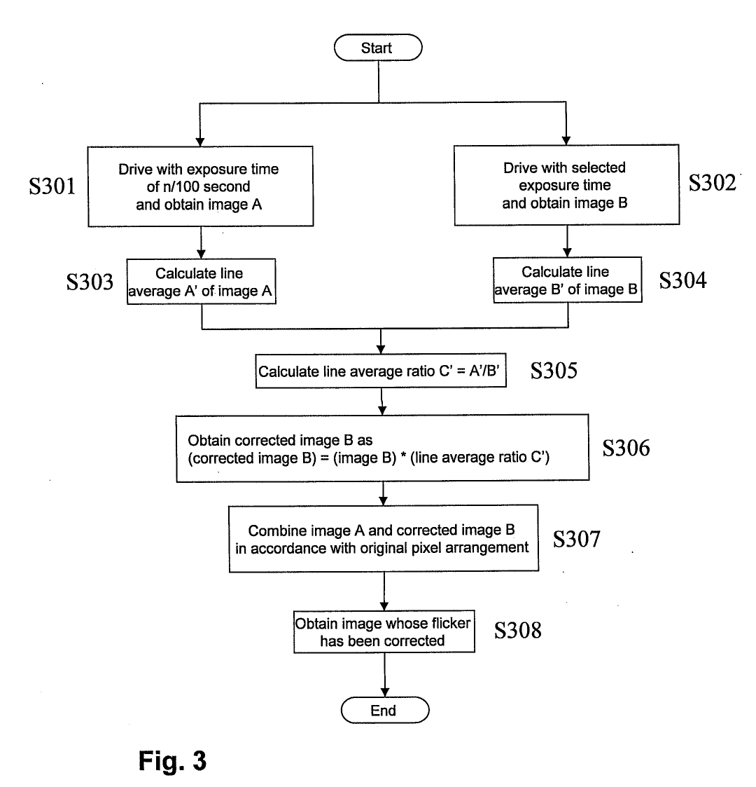

FIG. 3 is a flowchart showing the operation of the imaging apparatus 100.

Light from the subject is converted by photoelectric conversion, which is performed by the imaging unit 1, to generate an image-A signal and an image-B signal. The exposure time (charge accumulation time) for pixels A of the pixel unit 11 is set at n/100 second and the exposure time (charge accumulation time) for pixels B of the pixel unit 11 is set at a selected time (any selected time other than n/100 second) based on a charge accumulation time control signal, which is provided from the exposure time control unit 2.

As shown in FIG. 2, the image-A signal is obtained by accumulating charge in pixels A of the pixel unit 11 for the exposure time (n/100 second) set based on the charge accumulation time control signal, which is output from the exposure time control unit 2 (S301). The image-B signal is obtained by accumulating charge in pixels B of the pixel unit 11 for the exposure time (selected time) set based on the charge accumulation time control signal, which is output from the exposure time control unit 2 (S302).

The power supply frequency of the illumination is 50 Hz. In this case, the image-A signal obtained with the exposure time of n/100 second includes no flicker element, whereas the image-B signal includes a flicker element.

The image-A signal and the image-B signal are input into the image-B gain calculation unit 3. Based on the image-A signal, the image-B gain calculation unit 3 calculates an average value A′ for each line (horizontal line) of the image A, which is formed using the image-A signal (S303). The image-B gain calculation unit 3 further calculates an average value B′ for each line (horizontal line) of the image B, which is formed using the image-B signal (S304). The image-B gain calculation unit 3 calculates the ratio of the average values of the lines, which is written as C′=A′/B′ (S305). The calculated line average ratio, which is written as C′=A′/B′, is output from the image-B gain calculation unit 3 to the image-B gain correction unit 5 as the image-B gain correction coefficient.

The image-B signal is input into the delay unit 4. The delay unit 4 delays the image-B signal by the time required by processing performed in the image-B gain calculation unit 3, and outputs the delayed signal as an image-B delay signal to the image-B gain correction unit 5.

The image-B gain correction unit 5 multiplies the image-B delay signal corresponding to each line by the image-B gain correction coefficient (C′=A′/B′) to eliminate a flicker element from the signal (S306). The signal from which the flicker element has been eliminated is output as a corrected image delay signal from the image-B gain correction unit 5 to the image-A/B combining unit 6.

The image-A signal is input into the delay unit 4. The delay unit 4 delays the image-A signal by the time required by processing performed in the image-B gain calculation unit 3 and the image-B gain correction unit 5, and outputs the delayed signal as an image-A delay signal to the image-A/B combining unit 6.

The image-A delay signal and the corrected image-B delay signal are input into the image-A/B combining unit 6. The image-A/B combining unit 6 combines the image-A delay signal and the corrected image-B delay signal in the same arrangement as the arrangement of the imaging surface of the image unit 11 (same arrangement as the arrangement of the pixels of the pixel unit 11) to generate a corrected image signal (S307).

The corrected image signal is output from the image-A/B combining unit 6 as the image signal from which the flicker element has been corrected (eliminated) (S308).

As described above, the imaging apparatus 100 obtains the image-A signal including no flicker element and the image-B signal including a flicker element for each frame, calculates a correction coefficient used to eliminate the flicker element of the image B signal based on the image-A signal and the image-B signal, and eliminates the flicker element from the image-B signal based on the correction coefficient. The imaging apparatus 100 then combines the image-A signal and the image-B signal to generate an image signal from which the flicker element has been eliminated.

With the conventional method, a flicker element is detected only for a single frame out of a plurality of frames. For frames subsequent to the frame for which the flicker element has been detected, a gain correction value is calculated based on phase information of the flicker element that has been detected previously. With the conventional method, a flicker element is detected for one frame and then a flicker element of another frame is corrected.

In contrast, the imaging apparatus 100 of the present invention calculates a gain correction coefficient used in flicker correction based directly on information of a frame image to be corrected. More specifically, the imaging apparatus 100 detects a flicker element for one frame and corrects the flicker element of the same frame.

If the pixels in the even lines of the same imaging surface (imaging surface consisting of a plurality of pixels of the pixel unit 11 (image sensor)) and the pixels in the odd lines of the imaging surface are driven with two different exposure times, the imaging apparatus 100 would have vertical lines of noise generated on the image due to different correction gains of different pixels. To avoid this, the imaging apparatus 100 of the present invention drives pixels arranged on the same imaging surface (imaging surface consisting of a plurality of pixels of the pixel unit 11 (image sensor)) with two different exposure times in a manner that alternate pixels arranged in the vertical and horizontal directions are driven with one exposure time and the remaining alternate pixels are driven with the other exposure time. This reduces visibility of vertical lines of noise that occur on the processed image due to different exposure times.

As a result, the imaging apparatus 100 of the present invention enables effective flicker correction with small errors even when the illumination changes with time in the image capturing environment or when the imaging apparatus is moved to alternately capture an image of an indoor scene and an image of an outdoor scene.

### Other Embodiments

In the above embodiment, each block of the imaging apparatus may be formed by a single chip with semiconductor device technology, such as LSI (large-scale integration), or some or all of the blocks of the imaging apparatus may be formed by a single chip.

Although the semiconductor device technology is referred to as LSI, the technology may be instead referred to as IC (integrated circuit), system LSI, super LSI, or ultra LSI depending on the degree of integration of the circuit.

The circuit integration technology employed should not be limited to LSI, but the circuit integration may be achieved using a dedicated circuit or a general-purpose processor. A field programmable gate array (FPGA), which is an LSI circuit programmable after manufactured, or a reconfigurable processor, which is an LSI circuit in which internal circuit cells are reconfigurable or more specifically the internal circuit cells can be reconnected or reset, may be used.

Further, if any circuit integration technology that can replace LSI emerges as an advancement of the semiconductor technology or as a derivative of the semiconductor technology, the technology may be used to integrate the functional blocks of the imaging apparatus. Biotechnology is potentially applicable.

The processes described in the above embodiment may be realized using either hardware or software, or may be realized using both software and hardware. When the imaging apparatus of the above embodiment is realized by hardware, the timings at which each of the above processes is performed need to be adjusted. For ease of explanation, the timing adjustment of various signals generated in an actual hardware design is not described in the above embodiment.

The structures described in detail in the above embodiment are mere examples of the present invention, and may be changed and modified variously without departing from the scope and spirit of the invention.

### INDUSTRIAL APPLICABILITY

The imaging apparatus, the imaging method, the program, and the integrated circuit of the present invention enable effective correction (elimination) of a flicker element that occurs due to a power supply frequency of illumination. The imaging apparatus, the imaging method, the program, and the integrated circuit of the present invention are therefore useful in the video equipment related industry and have applicability in such industry.

What is claimed is:

1. An imaging apparatus, comprising:
an imaging unit including an image sensor having a first group of pixels and a second group of pixels that are driven independently of each other;
an exposure time control unit that sets an exposure time for the pixels included in the first group as a first exposure time with which no flicker element is generated and an exposure time for the pixels included in the second group as a second exposure time, and controls an exposure time for the first group to be the first exposure time and an exposure time for the second group to be the second exposure time;
an image-B gain calculation unit that calculates a gain correction coefficient for correcting a flicker element of an image-B signal based on an image-A signal including no flicker element obtained using the first group and the image-B signal obtained using the second group;
an image-B gain correction unit that corrects the flicker element of the image-B signal based on the gain correction coefficient; and
an image-A/B combining unit that combines the image-B signal whose flicker element has been corrected by the image-B gain correction unit and the image-A signal in accordance with an arrangement of the first group and the second group that are arranged on the image sensor.

2. The imaging apparatus according to claim 1,
wherein the imaging unit includes the image sensor in which the pixels included in the first group and the pixels included in the second group are arranged adjacent to each other in a vertical direction and a horizontal direction of an imaging surface of the image sensor.

3. The imaging apparatus according to claim 1,
wherein the exposure time control unit sets the first exposure time at n/100 second, where n is a natural number, when a power supply frequency of illumination is 50 Hz, and sets the first exposure time at n/120 second, where n is a natural number, when the power supply frequency of the illumination is 60 Hz.

4. An imaging method that is used in an imaging apparatus including an imaging unit whose image sensor has a first group of pixels and a second group of pixels that are driven independently of each other, the method comprising:
setting an exposure time for the pixels included in the first group as a first exposure time with which no flicker element is generated and an exposure time for the pixels included in the second group as a second exposure time, and controlling an exposure time for the first group to be the first exposure time and an exposure time for the second group to be the second exposure time;
calculating a gain correction coefficient for correcting a flicker element of an image-B signal based on an image-A signal including no flicker element obtained using the first group and the image-B signal obtained using the second group;
correcting the flicker element of the image-B signal based on the gain correction coefficient; and
combining the image-B signal whose flicker element has been corrected in the image-B gain correction step and the image-A signal in accordance with an arrangement of the first group and the second group that are arranged on the image sensor.

5. A storage medium storing a computer-readable program that is used in an imaging apparatus including an imaging unit whose image sensor has a first group of pixels and a second group of pixels that are driven independently of each other, the program enabling a computer to function as:
an exposure time control unit that sets an exposure time for the pixels included in the first group as a first exposure time with which no flicker element is generated and an exposure time for the pixels included in the second group as a second exposure time, and controls an exposure time for the first group to be the first exposure time and an exposure time for the second group to be the second exposure time;
an image-B gain calculation unit that calculates a gain correction coefficient for correcting a flicker element of an image-B signal based on an image-A signal including no flicker element obtained using the first group and the image-B signal obtained using the second group;
an image-B gain correction unit that corrects the flicker element of the image-B signal based on the gain correction coefficient; and
an image-A/B combining unit that combines the image-B signal whose flicker element has been corrected by the image-B gain correction unit and the image-A signal in accordance with an arrangement of the first group and the second group that are arranged on the image sensor.

6. An integrated circuit, comprising:
an imaging unit including an image sensor having a first group of pixels and a second group of pixels that are driven independently of each other;
an exposure time control unit that sets an exposure time for the pixels included in the first group as a first exposure time with which no flicker element is generated and an exposure time for the pixels included in the second group as a second exposure time, and controls an exposure time for the first group to be the first exposure time and an exposure time for the second group to be the second exposure time;
an image-B gain calculation unit that calculates a gain correction coefficient for correcting a flicker element of an image-B signal based on an image-A signal including no flicker element obtained using the first group and the image-B signal obtained using the second group;
an image-B gain correction unit that corrects the flicker element of the image-B signal based on the gain correction coefficient; and
an image-A/B combining unit that combines the image-B signal whose flicker element has been corrected by the image-B gain correction unit and the image-A signal in accordance with an arrangement of the first group and the second group that are arranged on the image sensor.

7. An integrated circuit that is used in an imaging apparatus including an imaging unit whose image sensor has a first group of pixels and a second group of pixels that are driven independently of each other, the integrated circuit comprising:
an exposure time control unit that sets an exposure time for the pixels included in the first group as a first exposure time with which no flicker element is generated and an exposure time for the pixels included in the second group as a second exposure time, and controls an exposure time for the first group to be the first exposure time and an exposure time for the second group to be the second exposure time;
an image-B gain calculation unit that calculates a gain correction coefficient for correcting a flicker element of an image-B signal based on an image-A signal including no flicker element obtained using the first group and the image-B signal obtained using the second group;
an image-B gain correction unit that corrects the flicker element of the image-B signal based on the gain correction coefficient; and
an image-A/B combining unit that combines the image-B signal whose flicker element has been corrected by the image-B gain correction unit and the image-A signal in accordance with an arrangement of the first group and the second group that are arranged on the image sensor.
